(19) United States
(12) Patent Application Publication
(10) Pub. No.: US 2006/0205256 A1
(43) Pub. Date: Sep. 14, 2006

(54) Adapter or socket device for testing semiconductor devices, and method for incorporating a semiconductor device in a socket or adapter device

(76) Inventor: Holger Hoppe, Mering (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/356,903

(22) Filed: Feb. 17, 2006

(30) Foreign Application Priority Data
Feb. 18, 2005 (DE) 10 2005 007 593.2

(51) Int. Cl. H01R 13/15

(52) U.S. Cl. 439/260

(57) ABSTRACT

An adapter or socket device is disclosed. In one embodiment, the device includes contact legs or contact arms with at least two contact tips that are adapted to be alternatively contacted with the contact pins or contact balls of the semiconductor device. In a further embodiment, when loading the adapter or socket device, a specific adaptation of variable mechanism for positioning the semiconductor device to be tested is performed to a predetermined position in which the contact balls or contact pins of the device are contacted by a first group of contact tips of the adapter or socket device only. Thus, a second group of contact tips may remain unused and be spared for a later use. This way, the replacement cycles of the inventive adapter or socket devices are extended, and thus the costs for testing semiconductor devices are reduced altogether.

### CROSS-REFERENCE TO RELATED APPLICATIONS

This Utility Patent Application claims priority to German Patent Application No. DE 10 2005 007 593.2, filed on Feb. 18, 2005, which is incorporated herein by reference.

### FIELD OF THE INVENTION

The present invention relates to an adapter or socket device for testing semiconductor devices, and to a method for incorporating a semiconductor device to be tested in an adapter or socket device.

### BACKGROUND

In the present context, the term semiconductor devices in general means integrated computing circuits such as analog or digital computing circuits, as well as semiconductor memory devices such as functional memory devices (PLAs, PALs, etc.) and table memory devices (ROMs or RAMs, in particular SRAMs and DRAMs).

For the common manufacturing of a plurality of semiconductor devices, a so-called wafer (a thin disc manufactured of monocrystalline silicon) is used as a rule. For the structuring of the later circuits, the wafer is subject to a number of working processes, e.g., coating, exposure, etching, diffusion and implantation processes. After the termination of the working processes, the semiconductor devices are individualized by the wafer being sawn apart or scratched and broken, so that the individual semiconductor devices or chips are then available for further processing.

After the structuring of the semiconductor devices (i.e., after the performing of the above-mentioned wafer processing, the devices that are still positioned on the wafer may be tested by means of appropriate test devices, for instance, in so-called disc tests. After the sawing apart (or the scratching and breaking, respectively) of the wafer, the devices—which are then available individually—are molded in a plastics mass, with the semiconductor devices obtaining specific housings or packages, e.g., so-called TSOP or FBGA housings. The semiconductor devices with a TSOP housing comprise contact pins at their sides, and those with a FBGA housing comprise contact balls at their bottom. Subsequently, the housed semiconductor devices may be subject to further test processes at one or a plurality of test stations.

Accordingly, semiconductor devices are usually subject to extensive tests for examining their functioning in the course of the manufacturing process in the semi-finished and/or finished state prior to their incorporation in corresponding semiconductor modules. By using appropriate test systems or analyzers, respectively, further test methods (e.g., so-called module tests) may also be performed after the incorporation of the semiconductor devices in the semiconductor modules so as to examine the interaction of the individual semiconductor devices in the semiconductor module.

For determining the reliability, the housed semiconductor devices are tested in so-called “burn-in” test systems, wherein an artificial ageing of the devices is caused by the creation of extreme conditions. In such a “burn-in” test system, a so-called “burn-in” test method is performed, wherein the semi-conductor device is subject to extreme conditions, e.g. an increased temperature (e.g. over 80° C. up to 125° C.), or an increased operational voltage, for generating an accelerated ageing of the semiconductor device.

In the test system, individual semiconductor devices that are positioned in the above-mentioned housings are loaded into an appropriate adapter or socket device and are, via same, connected with an appropriate test device. Subsequently, the semiconductor device positioned in the adapter or socket device is tested by the test system. In order to be able to simultaneously examine a plurality of semiconductor devices in one test system, a plurality of adapter or burn-in socket devices are arranged in the test system on a so-called test board (e.g., up to 320 adapter or socket devices per test board).

Conventional (burn-in) adapters or sockets may, for instance, consist of a basic element and a cover that can e.g. be shifted in vertical direction vis-à-vis the basic element. Spring elements that produce a spring tension between the basic element and the cover may be positioned at the basic element. By pressing the adapter or socket cover against the basic element, the adapter or socket can be “opened”, and subsequently the device that is positioned above the adapter or socket may be dropped into the adapter or socket, for instance, by a loading or gripping means (loader).

Inside the adapter or socket, appropriate introducing slants and seat fittings may be provided, which ensure that the device or the device housing, respectively, is exactly oriented when falling into the adapter. Known adapter or socket devices may further comprise separate utilities serving for the exact introduction of the semiconductor device to be tested into the adapter or socket device. Such utilities are, for instance, the so-called “guides”, i.e. inserts in the adapter or socket devices which are adapted to the dimensions of the semiconductor device to be tested and comprise the above-mentioned introducing slants and seat fittings. Due to the exchangeability of the separate utilities, “guides”, an adapter or socket device can be adapted to different semiconductor devices.

Once the semiconductor device to be tested has been placed exactly in the adapter or socket device by means of the “guides”, the adapter or socket may again be “closed” in that the pressure on the cover is released and the above-mentioned spring elements press the cover upwards. In so doing, the pins provided at the adapter or socket contact the contact pins or contact balls, respectively, of the semiconductor device, so that the device is electrically connected with the test system via the adapter or socket device and the above-mentioned test methods can be performed. Additionally, so-called “latches” or movable brackets, respectively, may be provided in the adapter or socket device, which fix the semiconductor device in its position in the adapter or socket.

For establishing the electric contact between the individual contact pins or contact balls, respectively, of the semiconductor device with the test system, the adapter or socket devices comprise contact arms that are moved by means of fine mechanics. The contact arms are equipped with sensitive contact tips contacting the contact balls or contact pins, respectively, of the semiconductor device to be tested. The lifetime—or else durability—of the adapter or socket device is therefore substantially influenced by the operability of the contact tips.

After a certain time, the contact tips will frequently be disturbed in their function by contamination. Since a cleaning of the contact tips is not possible or with difficulties only, the entire burn-in socket usually has to be exchanged when the contact tips are worn out. The usual exchange of defective burn-in sockets, however, involves much time and cost since no tests can be performed during this time. The exchange of burn-in sockets further means additional stress for the test board on which the burn-in sockets are arranged.

For these and other reasons, there is a need for the present invention.

### SUMMARY

The present invention provides a device for testing semiconductor devices and method. In one embodiment, the invention provides a device serving to incorporate a semiconductor device to be tested and to electrically connect the semiconductor device with a test system. A mechanism is provided for contacting contacts of a semiconductor device to be tested, the mechanism having contact legs with at least two contact tips, wherein the contact tips are adapted to be contacted alternatively with the contacts of the semiconductor device.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a schematic side representation of a part of an adapter or socket device according to one embodiment of the present invention, in which a semiconductor device to be tested is placed in a first position.

FIG. 2 illustrates a schematic side representation of the adapter or socket device illustrated in FIG. 1, in which a semiconductor device to be tested is placed in a second position.

FIG. 3 illustrates a schematic side representation of a part of the semiconductor or socket device according to a further embodiment of the present invention.

FIG. 4 illustrates a schematic top representation of a part of the adapter or socket device illustrated in FIG. 3.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention provides a socket or adapter device for testing semiconductor devices, and a novel method for incorporating a semiconductor device to be tested in a socket or adapter device, extending the durability of the adapter or socket devices for the semiconductor devices to be tested on the test system so as to reduce the operating costs of the test system.

In one embodiment, an adapter or socket device serving to incorporate a semiconductor device to be tested, and to electrically connect the semiconductor device with a test system, having means for contacting contact pins or contact balls, respectively, of the semiconductor device to be tested, wherein the means for contacting the contact pins or contact balls, respectively, of the semiconductor device to be tested comprise contact legs or contact arms, respectively, with at least two contact tips that are adapted to be contacted alternatively with the contact pins or contact balls, respectively, of the semiconductor device.

With an adapter or socket device according to the present invention, a first group of contact tips can consequently be used alternatively for contacting the contact balls or contact pins, respectively, of the semiconductor device to be tested, while a second group of contact tips remains unused. If the first group has become unusable, for instance, due to contamination, the second group of contact tips can be used alternatively for contacting the contact balls or contact pins, respectively, of the semiconductor device to be tested. This way, the replacement cycles of the inventive adapter or socket device can be extended, and thus the costs accruing during the manufacturing and testing of semiconductor devices can be reduced altogether.

In accordance with a further embodiment of the present invention, the above-mentioned object is solved by a method for incorporating a semiconductor device in a socket or adapter device, serving to incorporate a semiconductor device to be tested and to electrically connect the semiconductor device with a test system, comprising contact tips for contacting contact pins or contact balls, respectively, of the semiconductor device to be tested, and adjustable means for positioning the semiconductor device to be tested in the adapter or socket device, wherein the method comprises at least the following:
adjusting the means for positioning to a predetermined position of the semiconductor device to be tested in the adapter or socket device;
incorporating a semiconductor device to be tested in the adapter or socket device;
positioning the semiconductor device in the adapter or socket device in the predetermined position in which only particular contact tips cooperate with the contact pins or contact balls, respectively, of the semiconductor device; and
contacting the contact pins or contact balls, respectively, of the semiconductor device to be tested by means of the particular contact tips.

By the specific adaptation of the adapter or socket device and its variable means for positioning the semiconductor device to be tested to a first predetermined position in the adapter or socket device, it is possible to alternatively contact the contact balls or contact pins, respectively, of the semiconductor device by means of a first group of contact tips of the adapter or socket device only, while another group of contact tips remains unused. Once the first group of contact tips of the adapter or socket device has become unusable due to wear, the variable means for positioning the semiconductor device to be tested can be adjusted to a second predetermined position in the adapter or socket device in which the contact balls or contact pins, respectively, of the semiconductor device are contacted by means of the second group of contact tips of the adapter or socket device only, and so on. Thus, the duration of the adapter or socket device can be extended.

As housings for semiconductor devices, both conventional TSOP housings with contact pins and conventional FBGA housings with contact balls are used. Even if the following explanations relate to an adapter or socket device for testing a semiconductor device in a FBGA housing with contact balls, the inventive adapter or socket device can, on principle, also be used for semiconductor devices in a TSOP housing with contact pins.

In one embodiment of the present invention, two contact legs or contact arms, respectively, opposing each other are provided for contacting a contact ball. The opposing contact legs or contact arms, respectively, are arranged such that their contact tips are also opposing each other. The opposing contact legs or contact arms, respectively, are preferably opened or closed via mechanical kinematics, i.e., are moved away from each other or are moved towards each other.

By the opposing arrangement of the contact legs or contact arms, respectively, that are adapted to be moved towards each other, a forcipate movement of the contact arms is enabled, this resulting in reliable electric contact between the contact tips at the contact arms and the contact balls or contact pins, respectively, of the semiconductor device to be tested.

In another embodiment of the present invention, the contact tips are arranged at a contact leg or contact arm, respectively, one below the other at different levels. Thus, by means of the exact positioning of the semiconductor device to be tested in the adapter or socket in a particular seating height or seating plane, it is possible to select only those contact tips for contacting the contact balls or contact pins, respectively, which are positioned in the corresponding seating plane, while the other contact tips—outside the corresponding seating plane—remain unused and can be spared for later use.

Additionally or alternatively, the contact tips may be arranged at a contact leg or contact arm, respectively, side by side in a horizontal plane. Thus, by means of the exact positioning of the semiconductor device to be tested in a particular horizontal position in the adapter or socket, it is possible to select only those contact tips for contacting the contact balls or contact pins, respectively, which are positioned at the corresponding horizontal position, while the other contact tips—outside the corresponding horizontal position—remain unused and may be spared for later use.

It is particularly advantageous if a substantially V-shaped section is provided between the contact tips at a contact leg or contact arm, respectively, said section cooperating with the contact pins or contact balls, respectively, of the semiconductor device during contacting in that the contact pins or contact balls, respectively, of the semiconductor device are at least partially incorporated in the section between the contact tips during contacting.

In one embodiment, the adapter or socket device includes variable means for positioning the semiconductor device to be tested in the adapter or socket device, said means being adjustable such that only particular contact tips optionally cooperate with the contact pins or contact balls, respectively, of the semiconductor device. By means of these variable means for positioning the semiconductor device to be tested in the adapter or socket device, the desired horizontal and vertical position or seating plane, respectively, of the semiconductor device to be tested can be determined for the above-described purpose.

To this end, the adapter or socket device includes at least one sliding slant or seat fitting, respectively, for positioning the semiconductor device to be tested in the adapter or socket device, which determines in particular a predetermined horizontal position of the semiconductor device to be tested in the adapter or socket device. Additionally, or alternatively, the adapter or socket device may comprise mechanic stoppers in the form of bearing faces or seat bumps for positioning the semiconductor device to be tested in the adapter or socket device, which determine in particular a predetermined vertical position of the semiconductor device in the adapter or socket device.

To increase the variability of the adapter or socket device, a separate element in the form of a so-called “guide” may be provided, which is adapted to be introduced into the adapter or socket device and to be removed again. This separate element (guide) comprises preset or predimensioned positioning means such as sliding slants, seat fittings, and/or seat bumps, serving for the exact horizontal and vertical positioning of the semiconductor device in the adapter or socket device. To determine the contact tips that are to contact the contact balls or contact pins, respectively, of the semiconductor device to be tested, or to adapt the adapter or socket device to another semiconductor device with different dimensions, only the separate element (guide) has to be exchanged in the adapter or socket device.

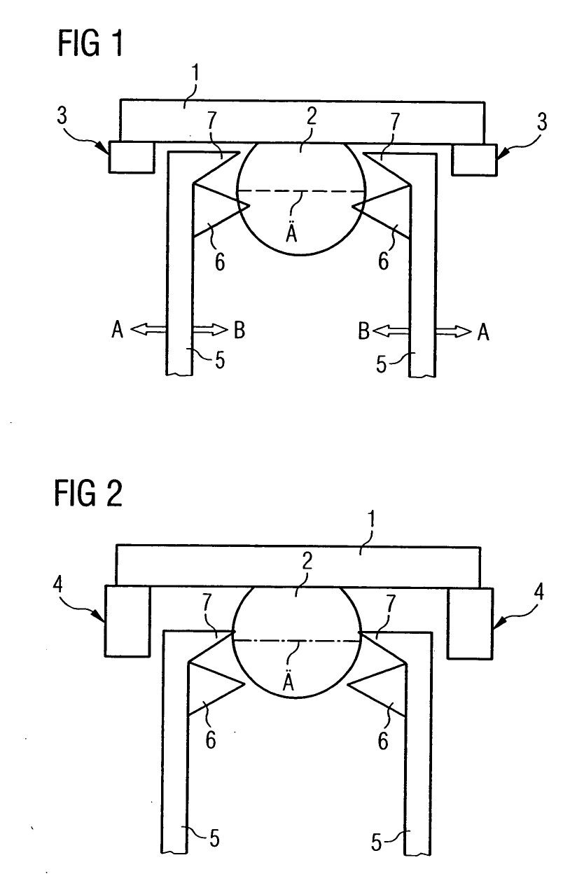

In accordance with a preferred embodiment of the inventive method for incorporating a semiconductor device in a socket or adapter device, the adjusting of the means for positioning the semiconductor device to be tested in the adapter or socket device can thus be performed by installing a separate element (guide) in the adapter or socket device, said element (guide) comprising preset or predimensioned means, in particular sliding slants, seat fittings, and/or seat bumps, for positioning the semiconductor device in the adapter or socket. FIG. 1 shows a schematic side representation of a part of the adapter or socket device according to a preferred embodiment of the present invention. The inventive adapter or socket device is used in a test system or a test station for testing semiconductor devices, which may e.g. be a so-called “burn-in” station, in particular a “burn-in” test station. At such a “burn-in” test station, an artificial ageing of the semiconductor devices is caused by the creation of extreme conditions. Additionally, one or a plurality of “burn-in” test methods may be performed at the “burn-in” station, i.e. tests under extreme conditions, e.g. increased temperature and/or increased operational voltage, etc.

A plurality of these sockets or adapters each may be connected to a test system or be arranged on a test board (not illustrated), respectively. The test board is connected to the test system (not illustrated) by means of electric lines. The test board is loaded into a furnace along with the sockets or adapters and the semiconductor devices loaded therein, where the semiconductor devices are subject to extreme conditions in the form of increased temperature, for instance, over 70° C., 100° C., or 150° C., and/or increased device operational voltage, etc.

As is illustrated in FIG. 1, a semiconductor device 1 is inserted in the adapter or socket device, the semiconductor device being a semiconductor device in a so-called FBGA housing that comprises contact balls 2 at its bottom. The part of the adapter or socket device illustrated in FIG. 1 serves to contact a contact ball 2 of the semiconductor device 1 to be tested. For contacting the semiconductor device 1, the adapter or socket device is equipped with contact legs or contact arms 5, at the free ends of which there are positioned contact tips 6, 7. The contact tips 6 touch the contact balls 2 of the semiconductor device 1 and are in electric contact therewith. To ensure a reliable contacting, two opposing contact legs or contact arms 5 are provided for every contact ball 2, the contact tips 6, 7 of which are opposing each other.

As described above, adapter or socket devices consist, as a rule, of a basic element and an adapter or socket cover (not illustrated) which are designed to be complementary to each other, so that the adapter or socket cover and the basic element can cooperate. When the semiconductor device 1 to be tested is inserted, the contact legs or contact arms 5 can be opened via appropriate kinematics in the direction of the arrow A by pressing the adapter or socket cover against the basic element of the adapter or socket device. After the insertion of the semiconductor device 1 into the adapter or socket device and the release of the adapter or socket cover, the contact legs or contact arms 5 are closed again in the direction of the arrow B, so that the contact tips 6 get into touch with the contact balls 2 or immerse therein to a particular depth, respectively, and thus electrically contact the contact balls 2 of the semiconductor device 1 to be tested. These mechanic kinematics can, in the case of an adapter or socket device without a cover, also be effected by a loading or gripping means.

From the adapter or socket device, test signals generated by the test system are, via the test board, transmitted to the socket pins (not illustrated) and further to the contact tips and to the housing pins contacting same, i.e. the contact pins or contact balls of the semiconductor device 1 to be tested. The signals output in reaction to the input test signals at corresponding semiconductor device contacts are then tapped by corresponding contact tips 6 and supplied via the adapters or sockets, the test board, and the lines to the test system where the signals of the tested semiconductor device 1 can be evaluated.

The contact tips 6, 7 at the contact legs 5 are positioned one below the other at different levels. In the representation of FIG. 1, the semiconductor device 1 to be tested is placed in a first or bottom position in which the contact balls or contact pins 2 of the semiconductor device 1 are merely contacted by the bottom contact tips 6 being in the vicinity of the equator line Ä of the contact balls 2, while the top contact tips 7 are not in contact with the contact balls 2. The semiconductor device 1 is positioned on seat bumps 3 ensuring a particular seating height or seating plane of the semiconductor device 1 in the adapter or socket device.

FIG. 2 illustrates a schematic side representation of the adapter or socket device illustrated in FIG. 1, in which a semiconductor device 1 to be tested is placed in a second position. The substantial difference to the representation of FIG. 1 consists in that the bearing faces or seat bumps 4 for the semiconductor device 1 are larger and thus define a higher seating height or seating plane of the semiconductor device 1.

By the higher positioning of the semiconductor device 1 to be tested in the adapter or socket in this second seating height or seating plane by means of the larger seat bumps 4, the top contact tips 7 positioned in the vicinity of the equator line Ä of the contact balls 2 are now getting into contact with the contact balls 2, while the other contact tips 6 remain unused.

The seat bumps 3, 4 may be designed as part of a separate element of the adapter or socket device in the form of a so-called “guide” that is adapted to be inserted into the adapter or socket device. This separate element (guide) may comprise, in addition to the seat bumps 3, 4, also other preset or predimensioned positioning means such as sliding slants and/or seat fittings serving for the exact horizontal and vertical positioning of the semiconductor device 1 in the adapter or socket device. To determine the contact tips 6, 7 that are to contact the contact pins or contact balls 2 of the semiconductor device 1 to be tested, or to adapt the adapter or socket device to another semiconductor device with different dimensions, only the height of the seat bumps 3, 4 has to be modified appropriately. This may, for instance, be effected by exchanging or inserting the separate element (guide) with the corresponding positioning means 3, 4 in the adapter or socket device.

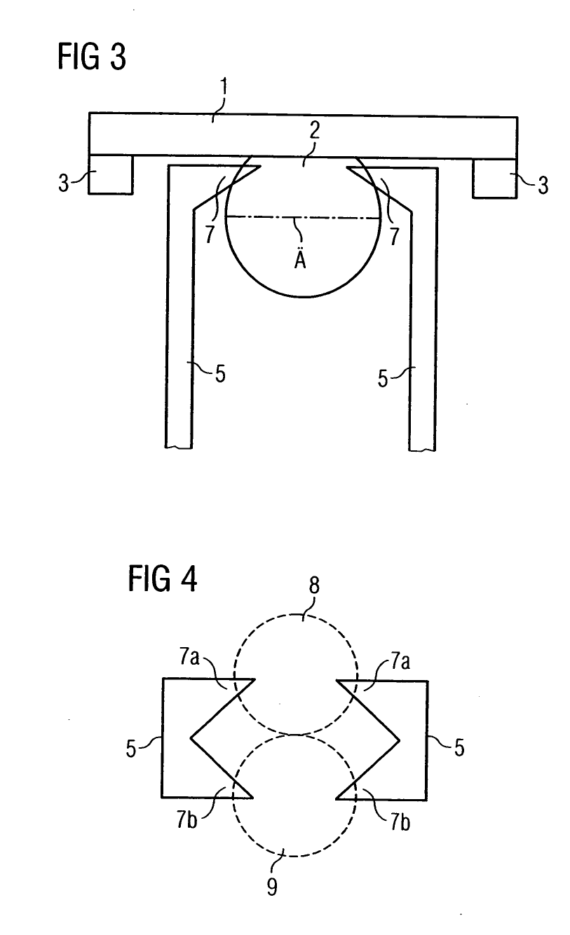

FIG. 3 illustrates a schematic side representation of a part of the adapter or socket device according to a further preferred embodiment of the present invention. In contrast to the embodiment illustrated in FIGS. 1 and 2, in the embodiment illustrated in FIGS. 3 and 4 the contact tips 7a and 7b are not positioned one below the other at a contact leg or contact arm 5, but in a horizontal plane side by side. The remaining arrangement of the adapter or socket device illustrated in FIG. 3 corresponds substantially to the embodiment of the invention as described in conjunction with FIGS. 1 and 2, so that the corresponding description is referred to for the sake of avoiding repetitions.

FIG. 4 illustrates a schematic top representation of a part of the adapter or socket device illustrated in FIG. 3. FIG. 4 reveals that, in the embodiment illustrated, each contact leg or contact arm 5 comprises, at its free end, two contact tips 7a and 7b that are positioned side by side, with a V-shaped section provided between them. For better overview, the representation of the semiconductor device 1 has been omitted, so that FIG. 4 schematically represents a direct top view of the contact tips 7a and 7b. The dashed circles 8, 9 each represent positions of the contact balls 2 of the semiconductor device 1 to be tested.

In this embodiment of the present invention, by an exact positioning of the semiconductor device 1 to be tested in a particular horizontal position in the adapter or socket device, the contact pins or contact balls 2 thereof are placed in particular horizontal positions 8 or 9. Thus, only the contact tips 7a are getting into contact with the contact balls 2 if they are in the horizontal position 8, while the other contact tips 7b outside the corresponding position 8 remain unused. If, however, the contact balls 2 are in the horizontal position 9, only the contact tips 7b are getting into contact with the contact balls 2, while the other contact tips 7a outside the corresponding position 9 remain unused.

Since the inventive adapter or socket device for the contacting of all the contact balls 2 of the semiconductor device 1 to be tested comprises a plurality of contact legs 5 with contact tips 6, 7 that are positioned one below the other, or contact tips 7a, 7b that are positioned side by side, a particular group of (bottom or top, or back or front, respectively) contact tips 6, 7, 7a, 7b can, by the vertical or horizontal positioning of the semiconductor device 1, alternatively be selected for contacting the contact balls 2. This way, the respective unused contact tips 6, 7, 7a, 7b can be spared for later use, or unused contact tips 6, 7, 7a, 7b can be used instead of worn contact tips 6, 7, 7a, 7b, respectively.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A device serving to incorporate a semiconductor device to be tested and to electrically connect the semiconductor device with a test system, comprising:
a mechanism for contacting contacts of a semiconductor device to be tested, the mechanism having contact legs with at least two contact tips, wherein the contact tips are adapted to be contacted alternatively with the contacts of the semiconductor device.

2. The device of claim 1, comprising:
wherein the contacts comprise contact pins.

3. The device of claim 1, comprising:
wherein the contacts comprise contact balls.

4. The device according to claim 1, wherein the contact tips are positioned at a contact leg one below the other at different levels.

5. The device according to claims 1, wherein the contact tips are positioned at a contact leg side by side in a horizontal plane.

6. The device according to claim 1, comprising:
a variable mechanism for positioning the semiconductor device to be tested in the adapter or socket device, the variable means being adapted to be adjusted such that, during contacting, only particular contact tips optionally cooperate with the contacts of the semiconductor device.

7. The device according to claim 1, comprising wherein the device comprises at least one sliding slant or seat fitting, respectively, for positioning the semiconductor device to be tested in the adapter or socket device, the sliding slant or seat fitting, respectively, determining in particular a predetermined horizontal position of said semiconductor device to be tested in the adapter or socket device.

8. The device according to claim 1, wherein the adapter or socket device comprises bearing faces or seat bumps for positioning the semiconductor device to be tested in the device, the bearing faces or seat bumps determining in particular a predetermined vertical position of the semiconductor device to be tested in the device.

9. The device according to claim 1, further comprising a separate element comprising preset or predimensioned positioning means such as sliding slants, seat fittings, and/or seat bumps for the precise horizontal and vertical positioning of the semiconductor device to be tested in the device.

10. The device according to claim 1, wherein, for contacting a contact, at least two contact legs are provided that are configured such that their respective contact tips are opposing each other.

11. The device according to claim 10, wherein the opposing contact legs and thus the opposing contact tips are opened or closed via mechanic kinematics, and configured to be moved away from each other in a first direction and moved towards each other in a second direction.

12. The device according to claim 1, comprising wherein, between the contact tips at a contact leg a substantially V-shaped section is provided that cooperates with the contacts of the semiconductor device during contacting in that the contacts of the semiconductor device are at least partially incorporated in the section between the contacts during contacting.

13. An adapter or socket device serving to incorporate a semiconductor device to be tested and to electrically connect the semiconductor device with a test system, comprising:
a mechanism for contacting contact pins or contact balls of the semiconductor device to be tested, the mechanism having contact legs or contact arms with at least two contact tips, wherein the contact tips are adapted to be contacted alternatively with the contact pins or contact balls of the semiconductor device.

14. The device according to claim 13, wherein the contact tips are positioned at a contact leg one below the other at different levels.

15. The device according to claims 13, wherein the contact tips are positioned at a contact leg side by side in a horizontal plane.

16. The device according to claim 13, comprising:
a variable mechanism for positioning the semiconductor device to be tested in the adapter or socket device, the variable mechanism being adapted to be adjusted such that, during contacting, only particular contact tips optionally cooperate with the contact pins or contact balls of the semiconductor device.

17. The device according to claim 15, comprising wherein the device comprises at least one sliding slant or seat fitting, respectively, for positioning the semiconductor device to be tested in the adapter or socket device, the sliding slant or seat fitting, respectively, determining in particular a predetermined horizontal position of said semiconductor device to be tested in the adapter or socket device.

18. The device according to claim 16, wherein the adapter or socket device comprises bearing faces or seat bumps for positioning the semiconductor device to be tested in the device, the bearing faces or seat bumps determining in particular a predetermined vertical position of the semiconductor device to be tested in the device.

19. The device according to claim 17, further comprising a separate element comprising preset or predimensioned positioning means such as sliding slants, seat fittings, and/or seat bumps for the precise horizontal and vertical positioning of the semiconductor device to be tested in the device.

20. The device according to claim 17, wherein, for contacting a contact, at least two contact legs are provided that are configured such that their respective contact tips are opposing each other.

21. The device according to claim 19, wherein the opposing contact legs and thus the opposing contact tips are opened or closed via mechanic kinematics, and configured to be moved away from each other in a first direction and moved towards each other in a second direction.

22. The device according to claim 20, comprising wherein, between the contact tips at a contact leg or contact arm a substantially V-shaped section is provided that cooperates with the contact pins or contact balls of the semiconductor device during contacting in that the contact pins or contact balls of the semiconductor device are at least partially incorporated in the section between the contacts during contacting.

23. A method for incorporating a semiconductor device in a socket or adapter device, serving to incorporate a semiconductor device to be tested and to electrically connect the semiconductor device with a test system, comprising contact tips for contacting contact pins or contact balls of the semiconductor device to be tested, and adjustable means for positioning the semiconductor device to be tested in the adapter or socket device comprising:
adjusting the means for positioning to a predetermined position of the semiconductor device to be tested in the adapter or socket device;
inserting a semiconductor device to be tested in the adapter or socket device;
positioning the semiconductor device in the adapter or socket device in the predetermined position in which only a first group of contact tips cooperates with the contact pins or contact balls of the semiconductor device; and
contacting the contact pins or contact balls of the semiconductor device to be tested by means of the first group of contact tips.

24. The method for incorporating a semiconductor device in a socket or adapter device according to claim 22, wherein the adjusting of the means for positioning the semiconductor device to be tested in the adapter or socket device is performed by installing a separate element in the adapter or socket device, the element comprising preset or predimensioned positioning means, in particular sliding slants, seat fittings, and/or seat bumps, for positioning said semiconductor device to be tested in the adapter or socket device.

25. A device serving to incorporate a semiconductor device to be tested and to electrically connect the semiconductor device with a test system, comprising:
means for contacting contact pins or contact balls of a semiconductor device to be tested, the mechanism having contact legs with at least two contact tips, wherein the contact tips are adapted to be contacted alternatively with the contacts of the semiconductor device.
